(19) United States
(12) Patent Application Publication
(10) Pub. No.: US 2018/0295799 A1
(43) Pub. Date: Oct. 18, 2018

(54) Vertical Hydroponic Horticulture System

(71) Applicant: Adrian L. WILTON, Staten Island, NY (US)

(72) Inventor: Adrian L. WILTON, Staten Island, NY (US)

(21) Appl. No.: 15/579,296

(22) PCT Filed: Jun. 2, 2016
(86) PCT No.: PCT/US16/35424

§ 371 Date: Feb. 2, 2018

Related U.S. Application Data
(60) Provisional application No. 62/170,112, filed on Jun. 2, 2015.

(51) Int. Cl. A01G 31/02; A01G 27/02

(52) U.S. Cl. CPC A01G 31/02; A01G 2031/006; A01G 27/02

(57) ABSTRACT

Various embodiments of vertical hydroponic horticulture systems are provided that maximize space saving features and provide improved convenience and recyclability. The hydro-ponic systems disclosed herein use a simple flexible mesh tube that can be tied at the bottom, and optionally tied at the top, and filed with a suitable growing medium for hydroponic agriculture. A plurality of perforations is provided in the mesh envelope for plants to grow on the exterior of the envelope with their roots in the medium inside the mesh envelope. An irrigation water drip may be provided at the top of the tubular flexible mesh tube, and a water collector may be provided at the bottom of the mesh tube, and a pump may be provided for recirculating the aqueous nutrient solution from the bottom of the mesh tube to the irrigation water drip at the top. In an embodiment, the mesh tube may be hung from an overhead supporting member. In an embodiment, the entire system may be self supporting by the use of a rigid pipe that acts as an internal skeleton through the center of the mesh tube.

### CROSS REFERENCE TO RELATED APPLICATION

This claims the benefit of U.S. Patent Application 62/170,112, filed Jun. 1, 2015, the entire contents of which are incorporated by reference.

### FIELD OF THE INVENTION

This invention relates generally to growing plant hydroponically in a vertical system.

### BACKGROUND

Hydroponic growing of plants is a method of growing plants in the absence of soil in which the roots are bathed in an aqueous nutrient solution. There are essentially two hydroponic methods. In the first method, the roots are suspended in an aqueous nutrient solution without support, and in the second method, the roots are supported in a matrix that is wetted by the aqueous nutrient solution. Typical supporting matrixes, also termed here a “growing medium,” include perlite, sand, or gravel, rather than conventional soil.

The aqueous nutrient solution will typically contain nitrate salts, phosphate salts, and sulfate salts, such as (for example) potassium nitrate, calcium nitrate, and magnesium sulfate. The solutions typically also contain metal ions, such as iron, copper, manganese, zinc, molybdenum, and boron

Soilless gardening offers potential advantages to conventional growing techniques in soil. Since a sterile medium may be used, there should be little or no weed growth, and soil-borne pests and diseases are minimized, if not eliminated completely. Properly grown hydroponic plants may also be healthier and more vigorous because all of the necessary growth elements are readily available. The plants can mature faster, yielding an earlier harvest of vegetable and flower crops. Hydroponic gardens use less space since the roots do not have to spread out in search of food and water. This small space requirement makes hydroponics ideal for home gardeners, and it makes better use of greenhouse space.

Hydroponic techniques also allow for precise water and nutrient application directly to the roots of each plant. Water is reused in these systems and less is lost through evaporation and run-off. Therefore, in arid areas, plants can be grown using limited amounts of water.

Many configurations for hydroponic growing hardware have been described and are commercially available. This disclosure pertains to vertically oriented methods of hydroponic growing. Such systems have been described, for example, in U.S. Pat. Nos. 4,454,684 and 5,715,629, and PCT publication WO 2012/04062. Each of these disclosures describe hydroponic growing systems oriented vertically. Vertically oriented systems have the advantage of a large growing area that can be used in a small space.

### BRIEF SUMMARY

Various embodiments of vertical hydroponic horticulture systems are provided herein that maximize space saving features and provide improved convenience and features over prior art systems. The inventive systems all use a simple flexible mesh tube that can be tied at the bottom, and optionally tied at the top, and filed with a suitable growing medium for hydroponic agriculture.

In an embodiment, a vertical hydroponic horticulture system is provided, with a flexible mesh envelope in a generally tubular configuration, wherein the tubular mesh envelope is oriented generally vertically with a top and bottom. The mesh envelope may be tied at the bottom. The envelope contains a plant growing medium. A plurality of perforations is provided in the mesh envelope for plants to grow on the exterior of the envelope with their roots in the medium inside the mesh envelope. An irrigation water drip may be provided at the top of the tubular flexible mesh tube, and a water collector may be provided at the bottom of the mesh tube, and a pump may be provided for recirculating the aqueous nutrient solution from the bottom of the mesh tube to the irrigation water drip at the top. In an embodiment, the mesh tube may be hung from an overhead supporting member.

In an alternative embodiment, the instant invention may be a self-supporting vertical hydroponic horticulture system with a flexible mesh envelope in a generally tubular configuration encapsulating a plant growing medium, with an internal skeleton that may be a rigid pipe longitudinally interposed within the mesh envelope that supports the mesh envelope enclosing the plant medium from within the envelope. In an embodiment, the mesh envelope is tied at the bottom end. In an embodiment, a plurality of perforations are provided in the mesh tube, through which seedlings or stems of plants may grow. The plants will therefore grow external to the envelope and through the perforations. The plant roots are supported in the plant growing medium.

### DESCRIPTION OF THE DRAWINGS

FIG. 1 shows a first embodiment of the inventive system, in a hanging format.

FIG. 2 shows a hanging embodiment of the inventive system, draped over an obstacle

FIG. 3 shows a cross sectional cut-away view of an embodiment of the inventive system, with an internal skeleton supporting member.

FIG. 4 shows an exterior view of an embodiment of the inventive system of FIG. 3, with an internal skeleton supporting member.

FIG. 5. is a perspective view of a plurality of hanging horticulture systems grouped together.

### DETAILED DESCRIPTION

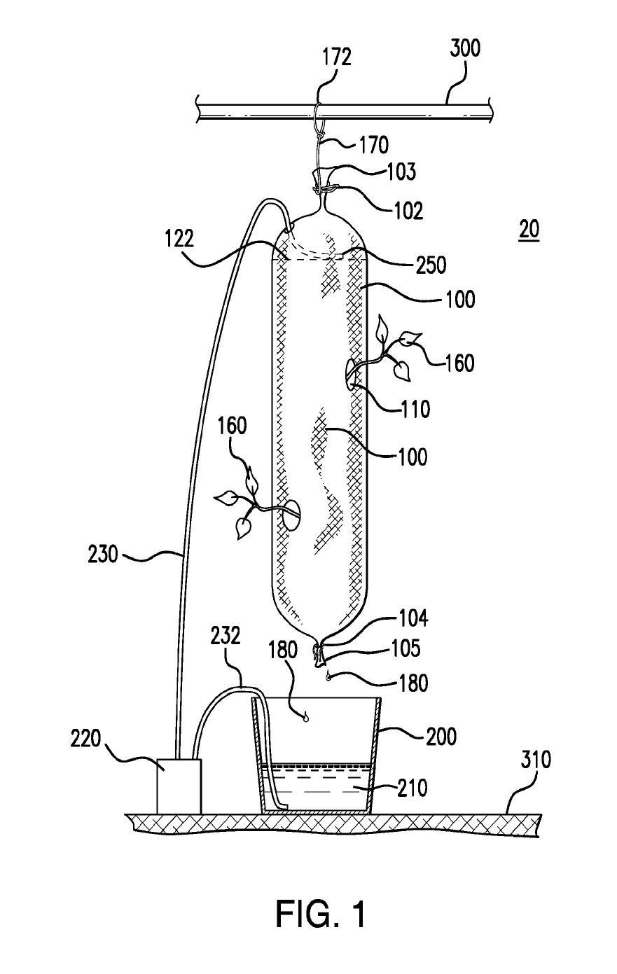

In an embodiment, shown in FIG. 1, a vertical hydroponic horticulture system 20 is provided, with a flexible mesh envelope 100 in a generally tubular configuration, wherein the tubular mesh envelope is oriented generally vertically with a top and bottom. The mesh envelope is tied at the bottom with a tie 104 that may be, for example, string or zip tie. The envelope contains a plant growing medium 122 and the mesh is a sufficiently fine grade to retain the plant growing medium therein. A plurality of perforations 110 is provided in the mesh envelope for plant stems to grow on the exterior of the envelope. An irrigation water drip 250 may be provided at the top of the tubular flexible mesh envelope, and a water collector is provided at the bottom of the mesh envelope, and a pump may be provided for recirculating water from the bottom of the mesh envelope to the irrigation water drip at the top.

The tubular mesh envelope may be for example, a high tensile strength polyethylene mesh tube product, such as the “erosion control tube” sold by Farmtek (www. farmtek.com). These mesh tubes are available in several diameters and lengths, including boxes with 100-foot rolls.

The plant growing medium may be, for example, perlite, clay pebbles, sand, gravel, growstone, glass beads, and plastic beads. In some embodiments, a chemically inert light weight material that does not absorb water is desirable. In embodiments, the mesh size of the mesh envelope and the particle size of the plant growing medium should match, so that particles of the plant growing medium don't pass through the mesh as if it was a sieve.

In an embodiment, the tube is tied at that top with tie 102. In an embodiment, supporting rope 170 may be integral with tie 102. As depicted in FIG. 1, rope 170 is looped around (loop 172) supporting member 300, which may be a beam or bar installed for the purpose of hanging plants.

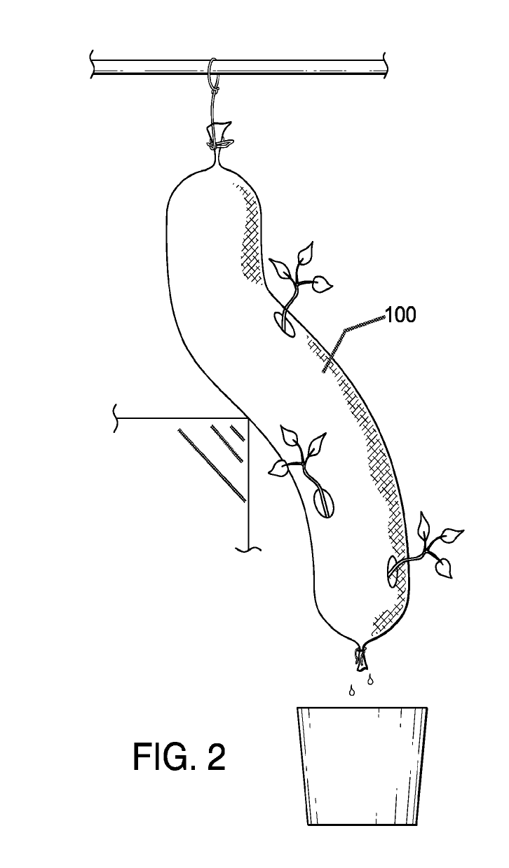

In an embodiment, the flexible mesh tube 100 may be draped over an obstacle (FIG. 2), such as an architectural feature, for example, a wall or building corner. Thus, the flexible nature of the mesh can be used to install the inventive hydroponic devices where they don't necessarily have to hang straight down.

In an embodiment, a receptacle 200 is provided underneath the mesh tubular envelope. The receptacle and pump 220 may rest on a floor 310. The receptacle collects the aqueous nutrient solution that drips down from the mesh tube in an embodiment (shown as water droplets 180 falling into the receptacle). The drippings collect in reservoir 210 in receptacle 200. A water siphon 232 may be used that leads to a water pump 220 that pumps the aqueous nutrient solution through water tube 230 to the top of the apparatus. A drip section 250 drips the water on the top surface 122 of the plant growing medium 120. In an embodiment, the receptacle 200 may be a 5-gallon (20-L) bucket such as the type commonly used in food preparation or construction. Smaller receptacles, such as having a having, for example, capacity of 1-L, 2-L, 4-L, or 8-L may also be used.

Perforations 110 may be provided in the envelope that allow the plants to grow through the envelope 100. As depicted in FIG. 1, plants 160 are shown growing on the exterior side of the tube, with a stem of the plant leading through the perforations 110 to the roots within the growing medium 120 contained in the tube 100.

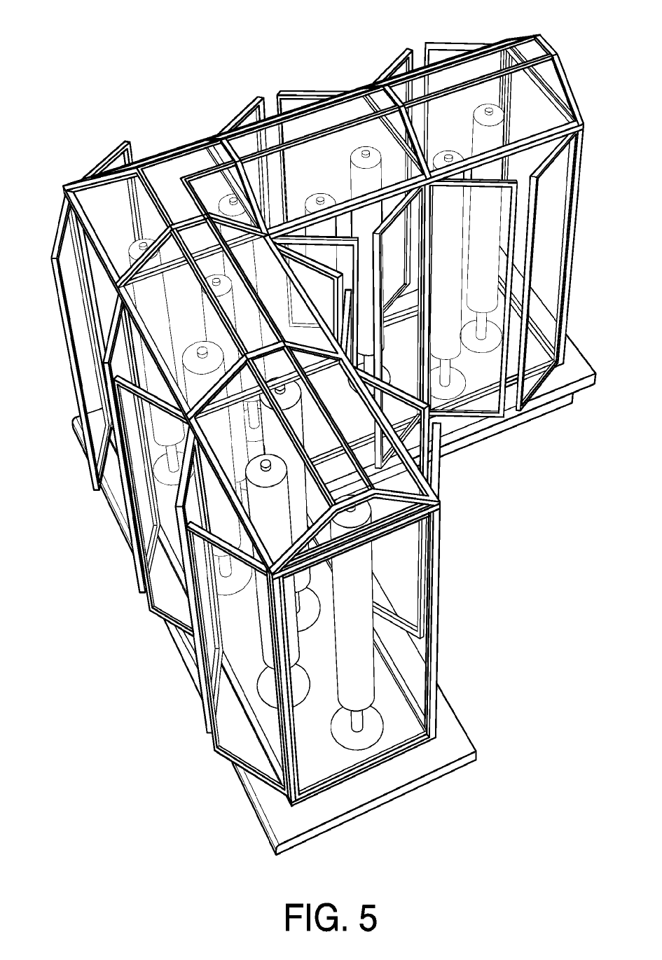

A plurality of vertical hydroponic horticulture systems 20 may be grouped together on a single supporting member 300, and hung in a limited space, such as a greenhouse. This is shown in an artist's conception in FIG. 5. In an embodiment, growing lights may be used.

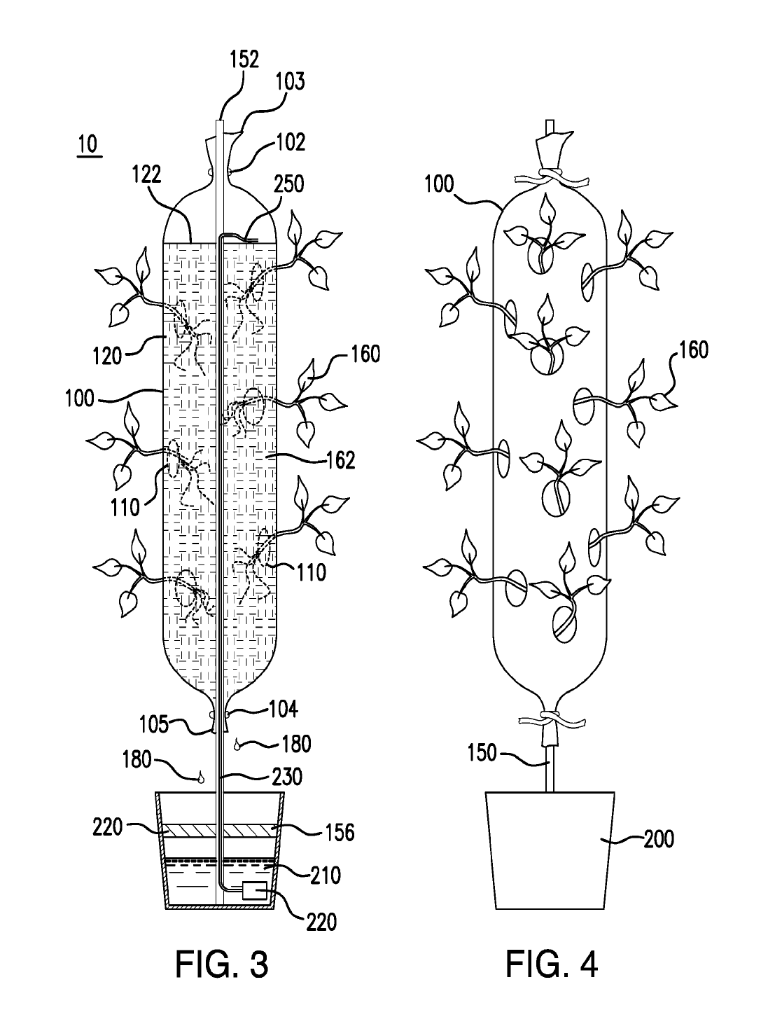

In an embodiment, the instant invention may be a self-supporting vertical hydroponic horticulture system 10 (FIGS. 3 and 4), with a flexible mesh envelope 100 in a generally tubular configuration enclosing a plant growing medium 120, with an internal skeleton that may be a rigid pipe 150 longitudinally interposed within the mesh envelope that supports the mesh envelope enclosing the plant medium from within the envelope. In an embodiment, the apparatus 10 has a generally vertical orientation, with a top and bottom. In an embodiment, the mesh envelope 100 is tied at the bottom end to contain the plant growing medium with a tying means 104. In an embodiment, the mesh envelope is also tied at the top with tie 102. Excess mesh material 103 and 105 is depicted in FIG. 3 where the flexible mesh envelope is tied off.

In an embodiment, a plurality of perforations 110 are provided in the mesh envelope 100, through which seedlings or stems of plants (160) may grow. The plants will therefore grow external to the envelope 100 and through the perforations 110. The plant roots 162 are supported in the plant growing medium.

In an embodiment, the pipe may be supported on its base at the lower end in a receptacle, such as a bucket. The receptacle collects water (i.e., the aqueous nutrient solution) that drips (water droplets 180) from the bottom of the mesh tube 100. The aqueous nutrient solution collects in reservoir 210 contained in receptacle 200.

In an embodiment, a water channel 230 such as a water tube runs through the pipe 150 from the base to the top of the plant growing medium. Water channel 230 is depicted in FIG. 3 as a solid line for brevity only. Water channel 230 may be, for example, a flexible ¼” ID latex or PVC tubing.

In an embodiment, a water pump 220 forces water in the reservoir in the receptacle up the water channel 230 to the top of the apparatus. The pump recirculates the aqueous nutrient solution. The water pump may be, for example, an impeller-type of pump. Such pumps are commonly used for fish tanks and are inexpensive and reliable. Alternatively, a Venturi-type of water pump can be used, in which a stream of pressurized air passes over an orifice connected to a water siphon, and a vacuum is created in the orifice that draws a liquid through the siphon. A Venturi-type of apparatus may have certain advantages, such as mechanical simplicity (if a source of forced air is available) and it aerates the solution that is forced up the tube 230. The pump may draw aqueous nutrient solution through openings 154 at the bottom of pipe 150.

In an embodiment, the water channel exits 230 the pipe 150 at the top of the mesh envelope and one or more perforations in the water channel (250) permit the aqueous nutrient solution to drip on to the top of plant growing medium (122). Thus, as the aqueous nutrient medium is dripped onto the top of the plant growing medium 120, the aqueous solution percolates through the growing medium and eventually drips (droplets 180) out the bottom of tube 100 into reservoir 210.

The rigid pipe may be PVC, metal such as steel or copper, ABS, etc. The pipe may be supported by the use of one or more brackets 156 mounted in the interior of receptacle 200. In an embodiment, the rigid pipe may rest in the reservoir 210. In an embodiment, there may be perforations in the wall of the rigid pipe near the bottom and top to allow the water tube 230 to pass through to the interior of the pipe.

In an embodiment, an aspect of this invention is the ability to efficiently recycle the mesh tube and the growing medium at the end of a plant growing cycle. As a general rule, once a growth of plants is harvested, the hydroponic growing medium must be refreshed. In one aspect, a point of hydroponic horticulture is the use of clean (if not sterile) growing media. In another aspect, the dead roots of a previous crop may be deleterious to a second crop in the same container if not removed. Thus, cleaning old, used growing media is important before using the media for a second planting. Because the hydroponic growing media of this invention is essentially chemically inert, there is no reason to discard the growing media following a planting cycle. The media can be cleaned and reused.

In accordance with this embodiment, the ties at the bottom (and top if used) can be removed and the growing media can be dumped out of the mesh tube and cleaned. In addition, the mesh tube can be cleaned. The cleaning may be as simple as washing the media and tube in soap and water to remove undesired organic matter. Old roots can be mechanically or manually removed.

In an embodiment, the perforations in the flexible mesh envelope tubes of this invention are manufactured prior to filling the mesh envelope with a plant growing medium, by cutting the mesh to form the perforations. In an embodiment, for each perforation, a flap may be made of the flexible mesh material, where the flap is affixed to an upper edge of each perforation on the interior of the mesh envelope, such that when the mesh envelope is tied on the bottom and filled with the plant growing medium, the flaps are pushed outward against the envelope causing the perforations to be sealed to prevent the plant growing medium from flowing out through the perforations. In a further embodiment, a lip of a plastic tubular material may be formed around the perimeter of each perforation, to give structural integrity to the edge of the perforation and give the flap a firm seat during the filling operation.

If the flap embodiment as just described is used, the flap must be manually pushed aside after filling to plant seeds or seedlings in the plant growing medium, so that the plants grow through the perforations.

The mesh apparatus 10 may be assembled by supporting the rigid pipe, slipping the flexible mesh envelope over the pipe, tying the mesh at a lower end of the pipe, and filling the mesh with the plant growing medium. The top may be optionally tied off. In an embodiment, perforations may be cut into the mesh where plants will grow out of the tube. If perforations are made in advance of the filling operation, they may be provided with flaps as described herein, to prevent the media from spilling out of the perforations during filling.

The mesh apparatus 20 may be assembled by tying the mesh tube at the bottom and filling the tube with growing media, for example with a funnel. The growing media may be fresh from a manufacturer, or it may be recycled media cleaned as described herein. If the perforations in the tube are made in advance of the filling operation, they may be provided with flaps as described herein, to prevent the media from spilling out of the perforations during filling.

1-4. (canceled)

5. A self-supporting vertical hydroponic horticulture system, comprising a flexible mesh envelope in a generally tubular configuration encapsulating a plant growing medium, with an internal skeleton comprising a rigid pipe longitudinally interposed within the mesh envelope that supports the mesh envelope in a generally vertical orientation, wherein the mesh envelope is tied at the bottom end to contain the plant growing medium, and with a plurality of perforations in the mesh envelope for plant stems to grow on the exterior of the envelope.

6. A self-supporting vertical hydroponic horticulture system, comprising a flexible mesh envelope in a generally tubular configuration having a top and a bottom, wherein the mesh envelope encapsulates a plant growing medium, wherein an internal skeleton comprising a rigid pipe is longitudinally interposed within the mesh envelope that supports the mesh envelope in a generally vertical orientation, wherein the mesh envelope is tied at the bottom end to contain the plant growing medium, and wherein a plurality of perforations in the mesh envelope for plant stems to grow on the exterior of the envelope and through the perforations; and
a. wherein the pipe is supported on its base at the lower end in a receptacle, and a reservoir of water is contained in the receptacle; and
b. wherein a water channel runs through the pipe from the base to the top of the plant growing medium;
c. wherein a water pump forces water in the reservoir of water in the receptacle up the water channel;
d. wherein the water channel exits the pipe at the top of the mesh envelope and one or more perforations in the water channel permit water to drip into the plant growing medium; and
e. wherein water falls from the bottom of the mesh envelope to replenish the reservoir.

7. The vertical hydroponic horticulture system of claim 6, wherein the pump is an impeller-type pump.

8. The vertical hydroponic horticulture system of claim 6, wherein the pump comprises a Venturi and an air supply that draws water from the reservoir and forces the water up the water channel.

9. The vertical hydroponic horticulture system of claim 6, wherein the mesh envelope is tied at the top.

10. The vertical hydroponic horticulture system of claim 6, wherein the base of the pipe is submerged in the reservoir.

11. The vertical hydroponic horticulture system of claim 6, wherein the bottom end of the water channel is submerged in the reservoir.

12. The vertical hydroponic horticulture system of claim 6, wherein the water channel passes through the wall of the rigid pipe through an opening at or near the bottom end of the pipe.

13-15. (canceled)

16. The vertical hydroponic horticulture system of claim 5 wherein the perforations in the mesh envelope are manufactured prior to filling the mesh envelope with a plant growing medium, and for each perforation, a flap made of the flexible mesh material is affixed to an upper edge of each perforation on the interior of the mesh envelope, such that when the mesh envelope is tied on the bottom and filled with the plant growing medium, the flaps are pushed outward against the envelope causing the perforations to be sealed to prevent the plant growing medium from flowing out through the perforations.

17. (canceled)

18. The mesh envelope of claim 5 wherein the perforations in the mesh envelope provided prior to filling the mesh envelope with a plant growing medium have a supportive lip circumferentially around each perforation, to support the flap that is pushed outward against the envelope when the envelope is filled with the plant growing medium.

19. The mesh envelopes of claim 5 wherein the plant growing medium is emptied from the mesh envelope after the plants thereon are harvested, and the plant growing medium is cleaned and the mesh envelopes are refilled with fresh or cleaned plant growing medium.

20. The mesh envelopes of claim 5 wherein the plant growing medium is selected from the group consisting of perlite, clay pebbles, sand, gravel, growstone, glass beads, and plastic beads, or a combination thereof.
